(19) United States
(12) Patent Application Publication
(10) Pub. No.: US 2012/0001358 A1
(43) Pub. Date: Jan. 5, 2012

(54) DRYING METHOD FOR CERAMIC GREENWARE

(75) Inventors: Terence J. Clark, Midland, MI (US); James J. O'Brien, Midland, MI (US)

(73) Assignee: Dow Global Technologies LLC

(21) Appl. No.: 13/166,298

(22) Filed: Jun. 22, 2011

Related U.S. Application Data
(60) Provisional application No. 61/358,487, filed on Jun. 25, 2010.
(60) Provisional application No. 61/380,802, filed on Sep. 8, 2010.

(51) Int. Cl. B28B 1/26

(52) U.S. Cl. 264/86

(57) ABSTRACT

The present invention is directed to a method comprising a) placing wet ceramic greenware body on a carrying structure, and b) exposing the wet ceramic greenware body to conditions such that the liquid carrier in the ceramic greenware body is substantially removed; wherein the carrying structure contains a carrying sheet comprising a material which retains its shape under drying conditions, the carrying sheet having two flat parallel faces and a plurality of walls perpendicular to the flat parallel faces wherein the walls form a plurality of flow passages communicating between the two faces wherein the largest distance between any two walls in the carrying sheet is about 6 mm or less and the walls have a sufficient thickness to support the wet ceramic greenware body under drying conditions without deforming and the area of the flow passages measured parallel to the two faces is from about 60 to about 90 percent by volume.

### CLAIM OF PRIORITY

This application claims priority from U.S. Provisional Application Ser. No. 61/358,487, filed Jun. 25, 2010; and from U.S. Provisional Application Ser. No. 61/380,802, filed Sep. 8, 2010; both incorporated herein by reference.

### FIELD OF INVENTION

The present invention relates to a method of drying wet ceramic greenware bodies with improved productivity.

### BACKGROUND

Ceramic parts are generally prepared by forming a mixture of a ceramic precursor, a binder and a liquid carrier, shaping the mixture into a near net shape, removing the liquid carrier, removing the hinder and then exposing the remainder of the components to conditions to form the ceramic structure. Typically, the ceramic structure is formed by heating the precursor to high temperatures, in some cases in the presence of a reactant. Removing the liquid carrier before removal of the binder and formation of the ceramic structure is necessary to allow the subsequent steps to function as desired. A preferred carrier is water. The shaped part resulting from the shaping step is referred to as greenware. Stresses are introduced into the greenware during removal of the liquid carrier. Such stresses can cause cracks in the greenware and the subsequent ceramic part. One class of ceramic parts for which this process is used are flow through filters. Flow through filters generally comprise structures having two opposing faces with channels or passages that extend from one face to the other face. In one embodiment, every other opening for the channels or passages are plugged on one end and the others are plugged on the other end. This means that for every channel all adjacent channels are plugged on the opposite end. The practical import of this structure is that when a fluid is introduced to one face of the filter it must flow into the open channels on that face and pass through the walls between the channels to the adjacent channels to reach the opposite face. Materials, such as solid particles that are larger than the pores in the walls are filtered out of the fluid and retained on the introduction side of the walls of the channels. The presence of cracks or defects in the final ceramic flow through filter can allow particles, that the filter is designed to retain, to pass through the cracks and defects to the second face of the flow through filter thereby rendering the filter ineffective. The step of removing the liquid carrier causes a significant percentage of ceramic greenware parts to crack or form voids or defects.

What is needed is a method for removing the liquid carrier from wet ceramic greenware wherein the occurrence of cracks, voids and defects are significantly reduced and are at a low level.

### SUMMARY OF THE INVENTION

In one embodiment the present invention relates to a method comprising a) placing wet ceramic greenware body on a carrying structure, and b) exposing the wet ceramic greenware body to conditions such that the liquid carrier in the ceramic greenware body is substantially removed; wherein the carrying structure contains a carrying sheet comprising a material which retains its shape under drying conditions, the carrying sheet having two flat parallel faces and a plurality of walls perpendicular to the flat parallel faces wherein the walls form a plurality of flow passages communicating between the two faces wherein the largest distance between any two walls in the carrying sheet is about 6 mm or less and the walls have a sufficient thickness to support the wet ceramic greenware body under drying conditions without deforming and the area of the flow passages measured parallel to the two faces is from about 60 to about 90 percent by volume.

In one embodiment, the carrying structure comprises a carrying sheet having sufficient properties and thickness to retain its shape, not deform, under liquid carrier removal conditions. In another embodiment, the carrying structure comprises a carrying sheet which is adapted to directly contact and support the wet ceramic greenware body and a support plate which functions to provide sufficient stiffness to the carrying structure so that the carrying structure retains its shape under liquid carrier removal conditions. Preferably, the liquid carrier is removed by placing the wet ceramic greenware body supported on the carrying structure in an oven. Preferably, the liquid carrier is removed by contacting the wet ceramic greenware body with a drying fluid or by exposing the wet ceramic greenware body to a vacuum. In one preferred embodiment, the wet ceramic greenware body is placed in an oven and a drying fluid is contacted with the wet ceramic greenware body or the wet ceramic greenware body is exposed to a vacuum. Preferably, the wet ceramic greenware body supported on the carrying structure is placed in an oven, either periodic (batch type) or belt driven (continuous throughput) and contacted with a drying fluid or exposed to a vacuum while in the oven.

It should be appreciated that the above referenced embodiments and examples are non-limiting, as others exist within the present invention, as shown and described herein. The methods of the invention result in a higher percentage of ceramic parts prepared which are crack, void and/or defect free. This results in a more efficient production method.

### DESCRIPTION OF THE DRAWINGS

FIG. 1 is a conventional carrier structure.

FIG. 2 is a cut away view of the conventional carrier structure of FIG. 1 along line 2-2 wherein the view is along a plane perpendicular to the face shown.

FIG. 3 is a view of a support plate useful in a carrier structure.

FIG. 4 is a cut away view of the carrier sheet located on the support sheet of the carrier structure of FIG. 3 along line 4-4 wherein the view is along a plane perpendicular to the face shown.

FIG. 5 is a view of a second embodiment of a support plate of a carrier structure.

FIG. 6 is a cut away view of a carrier sheet located on the second embodiment of a support sheet of the carrier structure of FIG. 5 along line 6-6 wherein the view is along a plane perpendicular to the face shown.

FIG. 7 is a view of the first embodiment of a carrier structure of the invention from above the carrier sheet disposed on the support sheet.

FIG. 8 is a view of the second embodiment of a carrier structure of the invention from above the carrier sheet disposed on the support sheet.

FIG. 9 is view of the first embodiment of the carrier structure of the invention located on a conveyor during the drying process.

FIG. 10 is view of the second embodiment of the carrier structure of the invention located on a conveyor during the drying process.

FIG. 11 illustrates an embodiment of a support sheet wherein an insert is used to create an air gap.

FIG. 12 is a cut away view of the support sheet of FIG. 12 showing also the carrier sheet disposed thereon.

FIG. 13 is a side view of an embodiment of a support structure wherein the carrying sheet is supported on the peripheral raised section of the support sheet.

### DETAILED DESCRIPTION OF THE PREFERRED EMBODIMENT

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. Other combinations are also possible as will be gleaned from the following claims, which are also hereby incorporated by reference into this written description. Each of the components introduced above will be further detailed in the paragraphs below and in descriptions of illustrative examples/embodiments.

The present invention is directed to a unique solution for removing the liquid carrier from wet ceramic greenware bodies wherein a low percentage of the resulting ceramic bodies contain defects, preferably the percentage of defective ceramic bodies is about 20 percent or less, more preferably 10 percent or less and 2 percent or less. Stated alternatively, the method results in a high percentage of defect free ceramic bodies, preferably 80 percent or greater of defect free bodies, more preferably about 90 percent or greater of defect free bodies and most preferably about 98 percent or greater of defect free parts. Defect as used herein means the ultimate (final) ceramic body contains a crack or void which interferes with function of the body. For instance, where the ultimate ceramic body is designed as a flow through filter a defect is a crack or void which passes particles through the walls of the ceramic body which the ceramic body is intended to filter out of a fluid stream, that is the body does not retain particles it is designed to retain and allows them to pass through walls of the body.

As used herein the term wet ceramic greenware means ceramic greenware containing a sufficient amount of liquid carrier to be shapeable. Generally this means that the greenware contains a significant amount of liquid carrier, for example from about 25 to about 35 percent by weight of the wet ceramic greenware. Substantially removed as used in the context of removal of the liquid carrier from the wet ceramic greenware means that the greenware can be subjected to removal of the binder and formation of the ceramic structure without the liquid carrier interfering in the process. In this context, substantially removed means that about 10 percent by weight or less of liquid carrier is retained in the ceramic greenware body and more preferably about 2 percent by weight or less.

Ceramic parts are generally prepared by contacting one or more precursors for the ceramic structure, ceramic precursors, optionally one or more binders and one or more liquid carriers. The ceramic precursors are the reactants or components which when exposed to certain conditions form a ceramic body or part. Any known ceramic precursors may be utilized in the formation of wet ceramic greenware bodies and ultimately ceramic bodies derived from the method of the invention. Included in ceramic precursors are the precursors utilized to prepare mullite bodies (such as disclosed in U.S. Pat. No. 7,485,594; U.S. Pat. No. 6,953,554; U.S. Pat. No. 4,948,766 and U.S. Pat. No. 5,173,349 all incorporated herein by reference), silicon carbide bodies, cordierite bodies, aluminum titanate bodies and the like. Binders useful in this invention include any known materials which render the wet ceramic greenware shapeable. Preferably, the binders are organic materials that decompose or burn at temperatures below the temperature wherein the ceramic precursors react to form ceramic bodies or parts. Among preferred binders are those described in Introduction to the Principles of Ceramic Processing, J. Reed, Wiley Interscience, 1988) incorporated herein by reference. A particularly preferred binder is methyl cellulose (such as METHOCEL A15LV methyl cellulose, The Dow Chemical Co., Midland, Mich.). Liquid carriers include any liquid that facilitates formation of a shapeable wet ceramic mixture. Among preferred liquid carriers (dispersants) are those materials described in Introduction to the Principles of Ceramic Processing, J. Reed, Wiley Interscience, 1988). A particularly preferred liquid carrier is water. The mixture useful in preparing wet ceramic greenware bodies may be made by any suitable method such as those known in the art. Examples include ball milling, ribbon blending, vertical screw mixing, V-blending and attrition milling. The mixture may be prepared dry (i.e., in the absence of a liquid carrier) or wet. Where the mixture is prepared in the absence of a liquid carrier, a liquid carrier is added subsequently utilizing any of the methods described in this paragraph.

The mixture of ceramic precursors, optionally binders, and liquid carriers may be shaped by any means known in the art. Examples include injection molding, extrusion, isostatic pressing, slip casting, roll compaction and tape casting. Each of these is described in more detail in Introduction to the Principles of Ceramic Processing, J. Reed, Chapters 20 and 21, Wiley Interscience, 1988, incorporated herein by reference. In a preferred embodiment the mixture is shaped into the near net shape and size of the ultimate desired ceramic body, such as a flow through filter. Near net shape and size means the size of the wet ceramic greenware body is within 10 percent by volume of the size of the final ceramic body, and preferably the size and shape is within 5 percent by volume of the size of the final ceramic body. Preferably the wet ceramic greenware body does not have any of the channels or flow passages blocked or plugged.

In a preferred embodiment, the wet ceramic greenware body is shaped such that it can be utilized as a flow through filter. At this stage in the process the wet ceramic greenware body has two opposing faces which are substantially planar. The wet ceramic greenware body exhibits a cross sectional shape which is consistent for all planes parallel to the two opposing faces. The cross-sectional shape can be any shape which is suitable for the intended use. The shape may be irregular or may be of any known shape. Preferably the cross-sectional shape is round, oval or polygonal. In one preferred embodiment, the shape is round, oval or rectangular (including square). If the shape is irregular, it is preferred that the shape have at least one surface that is planar such that the wet ceramic body can be disposed on the carrying sheet on the planar surface. The wet ceramic greenware body has a plurality of walls formed which extend from one opposing face to the other opposing face. The walls form a plurality of flow passages that extend from one opposing face to the other opposing face. Preferably, at this stage, all of the flow passages are open to both opposing faces. This allows more efficient removal of liquid carrier.

Thereafter the wet ceramic greenware body is subjected to conditions to remove the liquid carrier, that is to dry the wet ceramic greenware body. The wet ceramic greenware body is placed on a carrying structure while it is subjected to the liquid carrier removal conditions. The carrying structure performs the function of supporting the wet ceramic greenware body through the liquid carrier removal process. Additionally, the carrying structure performs one or more of the following functions: preventing the part of the wet ceramic greenware body in contact with the carrying structure from deforming; allowing one or more drying fluids to contact the part of the wet ceramic greenware body in contact with the carrying structure; and allowing any liquid carrier exiting the wet ceramic greenware body to move away from the wet ceramic greenware body.

The carrying structure consists of one or more carrying sheets in one embodiment. In another embodiment, the carrying structure comprises one or more carrying sheets and one or more support sheets. The one or more carrying sheets function to directly contact and support the wet ceramic greenware body during the liquid carrier removal process. Preferably only one carrying sheet is utilized. The one or more support sheets function to support the carrying sheet in manner that the wet ceramic body retains its shape, does not deform, during the liquid carrier removal process. The one or more support sheets may perform one or more of the following additional functions: facilitate contact of the drying fluid with the wet ceramic greenware body, facilitating flow of liquid carrier away from the ceramic greenware body, and facilitating the carrying the wet ceramic greenware body through processing steps. Preferably, the carrying structure contains one support sheet Retains its shape, or does not deform, means that the wet ceramic greenware body does not change in shape and the portion of the wet ceramic body in contact with the carrying structure remains substantially planar. In one embodiment, retains its shape, or does not deform, means that the wet ceramic greenware body portion in contact with the carrying structure does not dimple during the liquid carrier removal process.

The carrying sheets have two opposing faces parallel to one another which are planar, flat. Located between the faces is a series of interconnected walls perpendicular to the two faces. The walls form flow passages which traverse the thickness of the carrying sheets and are open on both faces. The flow passages allow fluids to pass from one face to the other face and thereby through the carrying sheet. The walls have a thickness sufficient to provide structure to the carrying sheets. Thickness in reference to the walls refers to the dimension of the walls in the direction parallel to the faces of the carrying sheet. The thickness is chosen such that the carrying sheet retains its shape under conditions utilized for liquid carrier removal. Preferably the walls have a thickness of about 0.1 mm or greater, more preferably about 0.2 mm or greater and most preferably about 0.3 mm or greater. Preferably the walls have a thickness of about 1.0 mm or less, more preferably about 0.5 mm or less and most preferably about 0.3 mm or less. The walls are interconnected in a manner such that under liquid carrier conditions the wet ceramic greenware body retains its shape, does not deform, under liquid carrier removal conditions. In a preferred embodiment, the walls form a repeating pattern, such as a series of regular interconnected shapes. Preferred shapes include ovals, circles, regular polygons and the like. More preferred shapes are circles and hexagons. In the embodiment wherein the shape is a hexagon, the pattern visible from the perspective of either face is a honeycomb pattern. The area of the flow passages from the perspective of each face of the carrying structure is selected such that the flow of fluids through the carrying structure facilitates contact of the drying fluid with the wet ceramic greenware body and removal of the liquid carrier from the vicinity of the wet ceramic greenware body. Preferably the area of the flow passages from the perspective of the faces of the carrying sheet is about 60 percent or greater and more preferably about 70 percent or greater. Preferably the area of the flow passages from the perspective of the faces of the carrying sheet is about 99 percent or less, more preferably about 95 percent or less, even more preferably about 90 percent or less and most preferably about 80 percent or less. The dimensions of the flow passages, distance between the walls, are chosen such that the wet ceramic greenware bodies retain their shape, do not deform, under liquid carrier removal conditions. If the dimensions of the flow passages are too large the portion of the wet ceramic greenware bodies in contact with the face of the carrying sheet can sag into the holes and permanently deform. The stress introduced can contribute to cracking and defects in the ceramic greenware bodies. The distance between the walls of the flow passages, the size of the flow passages transverse to the flow and parallel to the face of the carrying structure, is preferably about 6 mm or less, more preferably about 4.5 mm or less and most preferably about 3.5 mm or less. The distance between the walls of the flow passages, the size of the flow passages transverse to the flow and parallel to the face of the carrying structure, is preferably about 1 mm or greater and most preferably about 2.5 mm or greater. The carrier sheet can be prepared from any material that facilitates formation of the desired structure and which does not lose its shape, or deform, under conditions for liquid carrier removal. Glass, ceramic, and composite materials can be used in conjunction with the present invention so long as the materials can be processed such that open pathways can be created transverse to the plate thickness direction (e.g. honeycomb type) in order to fulfill requirement for airflow through the support plate thus enabling the drying of wet, green (unfired) filter parts. With regard to the drying support plate embodiments of the present invention, classes for additional materials selection may be selected from glass, ceramics, and composites, or comprised of any combination of the aforementioned classes including plastic and polymeric materials. This is because such materials offer specific factors including, but or not limited to, impact strength, rigidity, chemical durability, elevated temperature strength and processability. The carrier sheet preferably comprises a polymeric material, glass, ceramic material, composites, blends, alloys or two or more of the described materials.

Preferably the carrier sheet is composed of a material that has properties that match these criteria. Preferably, the material has a combination of heat distortion temperature, as determined by ASTM D648, and flexural modulus as determined by ASTM D790, such that the carrier sheet retains its shape, does not deform, under liquid carrier removal conditions. Preferably, the material has a heat distortion temperature (at 0.45 MPa load), as determined by ASTM D648, of about 163° C. or greater and more preferably about 204° C. or greater. Preferably, the material has a heat distortion temperature (at 0.45 MPa load), as determined by ASTM D648, of about 232° C. or less and more preferably about 218° C. or less. Preferably, the material has a modulus, as determined by ASTM D790, of about 2.5 GPa or greater and more preferably about 3.0 GPa or greater. Preferably, the material has a modulus, as determined by ASTM D790, of about 3.5 GPa or less and more preferably about 3.3 GPa or less.

Where the carrier sheet is composed of a polymer, preferably the polymer is a polyether imide, polysulfone, fiber reinforced nylon, polyether sulfone, polycarbonate, polyphenylene ether, blends or alloys thereof, and the like. Preferable polymeric materials include but are not limited to, polyphthalate carbonate (e.g., Lexan from General Electric) a high heat polycarbonate, polyphenylsulfone polymer (e.g., Radel R available from Solvay), polyethersulfone (e.g., Radel A available from Solvay), polyphenylene ether (e.g., SABIC PPO), transparent amorphous thermoplastic polymer (e.g., sulfone polymers sold under the trade name Supradel polymers available from Solvay), and combinations, blends, and/or alloys of two or more of the above. More preferred polymeric materials include polyether imide, polysulfone, fiber reinforced nylon, polyether sulfone, blends or alloys thereof. More preferred polymeric materials are polyether imides.

Composites useful for the carrier sheets include polymeric matrices of one or more thermoset or thermoplastic materials having dispersed therein reinforcing fibers or minerals. Preferred reinforcing fibers include glass, carbon fibers, natural mineral fibers, graphite fibers and the like. The reinforcing material may also be any natural mineral having a platy structure or high aspect ratio. Such minerals are well known in the art. Preferred composite systems for use in connection with the present invention, include high melting reinforced semi-crystalline polymers, such as, syndiotactic polystyrene reinforced with glass, minerals or combination thereof (e.g., Idemitsu Xarec), polyethylene terephthalate reinforced with glass, minerals or a combination thereof (e.g., Dupont Rynite), polyphenylene sulfide reinforced with glass, minerals or a combination thereof (e.g., Fortron), liquid crystal polymers (e.g., Celanese Ticona, DePont Vectra, Xydar polymers from Solvay), reinforced with glass, minerals or a combination thereof, Nylon or polyamide copolymers (e.g., Zytel and Zenite from DuPont, Amodel from Solvay), reinforced with glass, minerals or a combination thereof, polyester reinforced with glass, minerals or a combination thereof, graphite thermoset composites, and random fiber composites with polyolefin matrices.

Preferably the ceramic materials include aluminum oxide (all grades) aluminum nitride, cordierite, fused silica, glass-ceramics, magnesium oxide, mullite, mullite/cordierite mixtures, silicon carbide, silicon nitride, zirconium oxide, and the like ore preferred ceramic materials include aluminum oxide and mullite/cordierite mixtures.

Where the oven used in the process for removal of the liquid carrier is a microwave oven, the material used for the carrier plate is preferably microwave transparent. Microwave transparent material is defined as a material that does not couple at the spectrum of microwave frequencies and therefore does not heat when used in a microwave drying application. Any high temperature resistant material which exhibits low energy absorption in the radio frequency range may be used for the purposes of this invention. By low absorption, it is meant that the carrier plate material absorbs little or no energy in the radio frequency range. In a particularly preferred embodiment, the carrier plate absorbs less than 20 percent, more preferably, less than 10 percent of the energy in the field. Preferred microwave transparent materials include of nonpolar amorphous materials as well as nonpolar reinforced semi-crystalline materials. Additionally, for convection drying applications, polar high temperature plastic and/or polymers (i.e., thermosetting epoxies), glass, ceramic, and composites (i.e., epoxy composites) can be included as materials for use in connection with the present invention.

The carrier sheet has a thickness as measured from one opposing face to the other opposing face such that the face of the carrier plate in contact with the wet ceramic greenware body retains its' planar shape, does not deform under liquid carrier removal conditions. A suitable thickness is dependent upon whether the carrier sheet is self supporting or disposed on a support sheet. If the carrying sheet is self supporting it may need to be thicker than if a support sheet is utilized, alternatively the carrying sheet may be thinner is a support sheet is utilized. Generally, the thickness of the carrying sheet is preferably about 1.0 cm or greater, more preferably about 1.5 cm or greater and most preferably about 2.0 cm or greater. Generally, the thickness of the carrying sheet is preferably about 4.0 cm or less and most preferably about 3.0 cm or less. Where the carrying sheet is used without a support sheet, is self supporting, the thickness of the carrying sheet is preferably about 1.5 cm or greater and most preferably about 1.75 cm or greater. Where the carrying sheet is used without a support sheet, is self supporting, the thickness of the carrying sheet is preferably about 4.0 cm or less, more preferably about 3.0 cm or less and most preferably about 2.0 cm or less. Where the carrying sheet is used with a support sheet, the thickness of the carrying sheet is preferably about 1.5 cm or greater and most preferably about 1.75 cm or greater. Where the carrying sheet is used with a support sheet, the thickness of the carrying sheet is preferably about 3.0 cm or less, more preferably about 2.5 cm or less and most preferably about 2.0 cm or less. It is a combination of features which facilitates the carrier sheet having the property of retaining its shape under liquid removal conditions. The carrying sheet thickness and the heat distortion temperature and the modulus of the material from which the carrying sheet is fabricated are important variables. Also relevant is whether a support sheet is utilized. One skilled in the art is capable of balancing these criteria within the defined parameters to achieve the desired stiffness under liquid removal conditions. The carrying sheet has one or more outer edges, depending on the shape of the carrying sheet from the perspective of the opposing faces. The shape can be any shape which allows the carrying sheet to support a wet ceramic greenware body while exposed to liquid carrier removal conditions. Preferably the shape of the carrier sheet from the perspective of the two opposing faces is round, oval or polygonal. More preferred shapes are round, oval rectangular (including square) or hexagonal.

In the embodiment wherein the carrying sheet is utilized without a support sheet, the carrying sheet can include features which enhance its desired function. Among such features are molded edges on the sides perpendicular to the two opposing faces, indexing holes in the edges or in the corner of the carrying sheet (for instance drilled in the corner of a honeycomb), and the like. Such features can be incorporated utilizing procedures well known to those skilled in the art.

The support sheet, when utilized, functions to support the carrying sheet; prevent the carrying sheet from deforming; facilitate contact with the drying fluid with the wet ceramic greenware body; functions to carry the carrying sheet with the wet ceramic greenware body disposed thereupon through one or more processing steps (for instance through the drying process) and/or facilitate removal of the liquid carrier from the vicinity of the wet ceramic greenware body; during the liquid carrier removal process. The support sheet exhibits sufficient stiffness to allow the carrying sheet to retain its shape during the liquid carrier removal process. The support sheet also has sufficient open area in the direction parallel to the faces of the carrier sheet to allow transport of the drying fluid and liquid carrier through the support sheet and the carrier sheet. Typically, the support sheet comprises a sheet of material which meets these criteria. Such sheet preferably has two opposing faces parallel to one another and a thickness sufficient to provide stiffness to the carrying sheet. Preferably the support sheet has a thickness, measured as the distance from the two opposing faces, of about 0.5 cm or greater and more preferably about 0.8 cm or greater. Preferably the support sheet has a thickness, measured as the distance from the two opposing faces, of about 2.0 cm or less, more preferably about 1.5 cm or less and most preferably about 1.2 cm or less. Because the support sheet does not contact the wet ceramic greenware body, the support plate does not have a restriction on the size of the openings transverse to the two opposing faces of the support plate. It is desirable that the support sheet have as much open space as possible to facilitate the transport of fluids there through. Preferably the area of the openings in the support sheet from the perspective of the faces of the support sheet is about 60 percent or greater and more preferably about 70 percent or greater. Preferably the area of the openings in the support sheet from the perspective of the faces of the support sheet is about 90 percent or less and more preferably about 80 percent or less. The support sheet can comprise any material that provides the recited properties. Preferably the support sheet comprises a polymer, more preferably a polymer as described above as useful for the carrying sheet. Where the oven used in the process for removal of the liquid carrier is a microwave oven, the polymer used for the support plate is preferably microwave transparent. Preferably the support sheet has a recess adapted for seating the carrier sheet on the support sheet. Preferably the support sheet comprises a means for cooperating with a conveyor system to retain the carrier structure in the proper location on the conveyor system and facilitate movement of the carrier structure along the conveyor. Preferably such means includes indexing holes on the support structure which match mating protrusions or structures on the conveyor.

The support sheet preferably has a raised portion about the periphery of one face, preferably the face that a carrying sheet is placed on, wherein the raised portion defines a recess from the plane defined by the raised portion. Preferably the support sheet has a ledge for holding the carrier sheet in place which defines a plane below the raised portion and the central part of the support sheet, and preferably in a manner such that the carrying sheet is raised above the face of the center of the support sheet so that the fluid can flow between the face of the support sheet and the carrying sheet and out through the passages in the carrier sheet. The ledge can be inset in the recess of the support sheet adapted to support the carrier sheet. In another embodiment the ledge can be a separate part that is inset into the recess of the support sheet. In this embodiment the ledge insert can be prepared from any material useful as the support sheet. In embodiments where the carrying sheet is self supporting, a support sheet may be utilized to facilitate moving the wet ceramic greenware body through processing. In this embodiment the center of the sheet can be open with a ledge sufficient to hold the carrying sheet in place. Alternatively, the support sheet can have holes in the area surrounded by the ledge. In this embodiment the ledge needs to have sufficient thickness transverse to the face of the support sheet to create an air gap between the support sheet face in the center and the carrying sheet so that fluid can flow to all of the passages in the carrying sheet not resting in the ledge. This is to facilitate the flow of drying fluid through all of the passages not resting in the ledge. In the embodiment wherein the carrying structure is not self supporting the support plate needs to have sufficient points of contact with the carrying structure to keep the carrying plate flat. In another embodiment the carrying sheet can be large enough to set on the raised portion about the periphery of the support sheet such that the recess forms an air gap that allows the drying fluid to flow into the air gap and to and through the passages in the carrying sheet.

The method of the invention for removing liquid carrier from a wet ceramic greenware body involves placing the wet ceramic body on a carrier structure and placing the wet ceramic greenware body on the carrier structure in an oven under conditions such that the liquid carrier is substantially removed from the ceramic greenware body. In one embodiment, one face of the wet ceramic greenware body is placed on carrier structure. This process is generally utilized when the wet ceramic greenware body has an irregular cross-sectional shape, that is without a planar surface that can support the wet ceramic greenware body on the carrier plate or when the wet ceramic greenware body has a circular or oval cross-sectional shape. In another embodiment, a planar surface of the wet ceramic greenware body having a planar surface from the perspective of its cross-sectional shape, has a flat outside surface, is placed on the carrier structure. This is used when the wet ceramic greenware body has a cross sectional shape with a planar surface that can support the wet ceramic greenware body on its side, for instance when the wet ceramic greenware body has a polygonal, preferably rectangular, cross-section.

Any oven which assists in removing the liquid carrier from the wet ceramic body may be utilized in this method. Among preferred ovens useful in the invention are convection, infrared, microwave, radio frequency ovens and the like. In a more preferred embodiment a microwave oven is preferred. The wet ceramic body on a carrier structure may be placed in an oven for a sufficient time for the liquid carrier to be substantially removed from the ceramic greenware body and then removed from the oven. The wet ceramic body on a carrier structure can be manually placed in and removed from the oven. Alternatively the wet ceramic body on a carrier structure can be automatically introduced and removed from an oven. Any automatic means for introducing a part into and removing a part from an oven may be utilized. Such means are well known in the art. In a preferred embodiment, the wet ceramic body on a carrier structure is placed on a conveyor and passed through one or more ovens on the conveyor. The residence time of a wet ceramic body on a carrier structure in the one or more ovens is chosen such that under the conditions of the one or more ovens substantially all of the liquid carrier is removed. The residence time is dependent upon all of the other conditions, the size of the wet ceramic greenware structure and the amount of liquid carrier to be removed. The temperature that the wet ceramic body on a carrier structure is exposed to in the one or more ovens is chosen to facilitate the removal of the liquid carrier from the wet ceramic body. Preferably the temperature is above the boiling point of the liquid carrier and below the softening temperature of material from which the carrier structure is fabricated and the temperature at which any of the ceramic precursors decompose. Preferably, the temperature that the wet ceramic body on a carrier structure is exposed to in the oven is about 60° C. or greater, more preferably about 80° C. or greater and most preferably about 100° C. or greater. Preferably, the temperature that the wet ceramic body on a carrier structure is exposed to in the oven is about 120° C. or less and most preferably about 110° C. or less.

The wet ceramic greenware body in the oven is preferably contacted with a drying fluid or a vacuum is applied to the oven to facilitate removal of liquid carrier from the wet ceramic body. Preferably, the wet ceramic greenware body is contacted with a drying fluid. In the embodiment, wherein the wet ceramic greenware body is shaped as the precursor to a flow through filter, wherein the flow passages in the wet ceramic greenware body have not been plugged at one end, it is preferable to flow the drying fluid through the flow passages of the wet ceramic greenware body. This is facilitated by directing the drying fluid to flow in the same direction as the flow passages are disposed on the carrier structure. If one face of the wet ceramic greenware body is disposed on the carrier structure, the drying fluid is directed up through the carrier structure in the direction of the wet ceramic greenware body so that the drying fluid passes into and through the flow passages in the wet ceramic greenware body. Where the wet ceramic greenware body has a flat planar side and the wet ceramic greenware body is disposed on the carrier structure on its flat planar side, the flow of the drying fluid is directed to flow through the flow passages in the wet ceramic greenware body. In the embodiment wherein the wet ceramic greenware body on the carrier structure is passed through one or more ovens on a conveyor, wet ceramic greenware bodies are disposed such that the direction of the flow passages are transverse to the direction of the conveyor and the drying fluid is passed in a direction transverse to the direction of the conveyor such that the drying fluid passes through the flow passages of the wet ceramic greenware bodies. The drying fluid can be any fluid which enhances the removal of liquid carrier from the vicinity of the wet ceramic greenware body. Preferably the drying fluid is a gas. Preferred gasses include air, oxygen, nitrogen, carbon dioxide, inert gasses and the like. Most preferably the drying fluid is air. After the drying fluid is contacted with the wet ceramic greenware body it is removed from the vicinity of the wet ceramic greenware body along with the liquid carrier entrained in the drying fluid. The flow of drying fluid is generated by any means which facilitates movement of a drying fluid such as a pump, a blower, and the like. The flow rate of the drying fluid is chosen to facilitate the removal of liquid carrier from the vicinity of the wet ceramic greenware body. The preferable flow rate will vary depending on a variety of conditions. Determination of a suitable flow rate is within the ability of one skilled in the art. Preferably the flow rate is about 1000 cu.m/h (cubic meters/hour) or greater and more preferably about 1650 cu.m/h or greater. Preferably the flow rate is about 2000 cu.m/h or less and more preferably about 1680 cu.m/h or less.

Other important parameters for drying ceramic parts that are afforded utility by the carrier plate of the present invention are: two frequency regimes of microwave power (2.45 GHz and 915 MHz), varied reflected powers at those frequencies (from about 0 to about 100%), relative humidity that can vary from about 0 to about 100%, residence time that can vary from about 0.01 to about 10 hours in periodic oven or belt driven continuous ovens, and a maximum part temperature that can range from about 50 to about 150° C.

After removal of the liquid carrier from the wet ceramic greenware body, the ceramic greenware body can be prepared for conversion to a ceramic body and converted to a ceramic body. In the embodiment wherein the ceramic greenware body is a precursor to a flow through filter, every other flow passage on each end is plugged, preferably with shapeable ceramic greenware, wherein each flow passage is open on one end and each flow passage that is open on one face has plugged flow passages adjacent to its open passage. Thereafter, the ceramic greenware body is exposed to conditions to burn out the binder and to form the ceramic structure. Processes to achieve this are well known in the art.

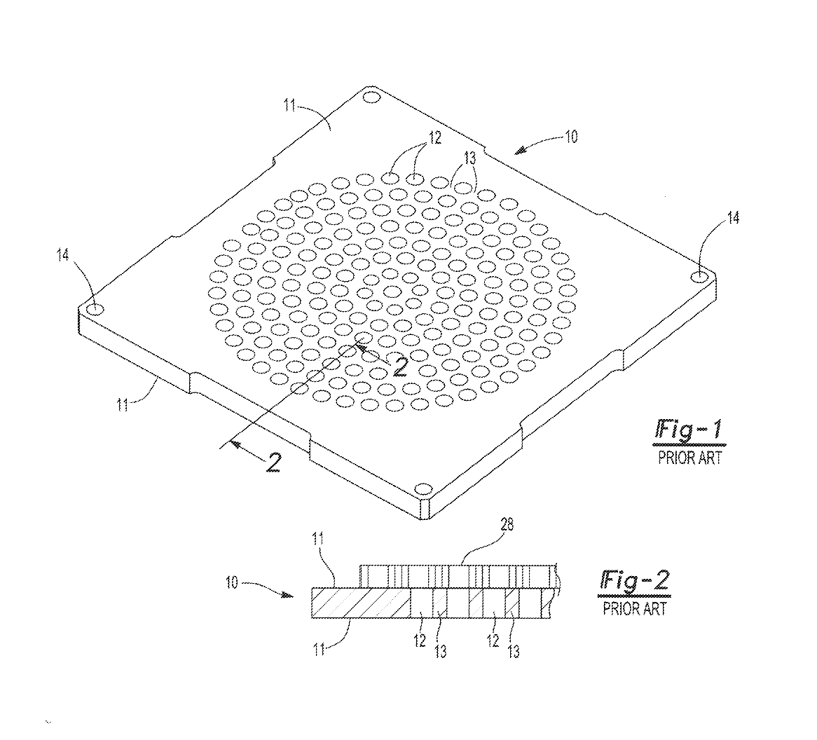

FIG. 1 is a drawing of the conventional carrying sheet 10 showing one of two opposed faces 11, a plurality of 1 cm holes 12 and plastic material located between the holes 13. Also shown are indexing holes 14 for orienting the carrying sheet 10 on a conveyor belt, not shown in FIG. 1. FIG. 2 is a cut away view of the prior art sheet taken along line 2-2. The view is perpendicular to face 11 along the designated line. FIG. 2 shows the carrying sheet 10 and the edge of the two faces 11. Also shown are the holes 12 and the material located between the holes 13.

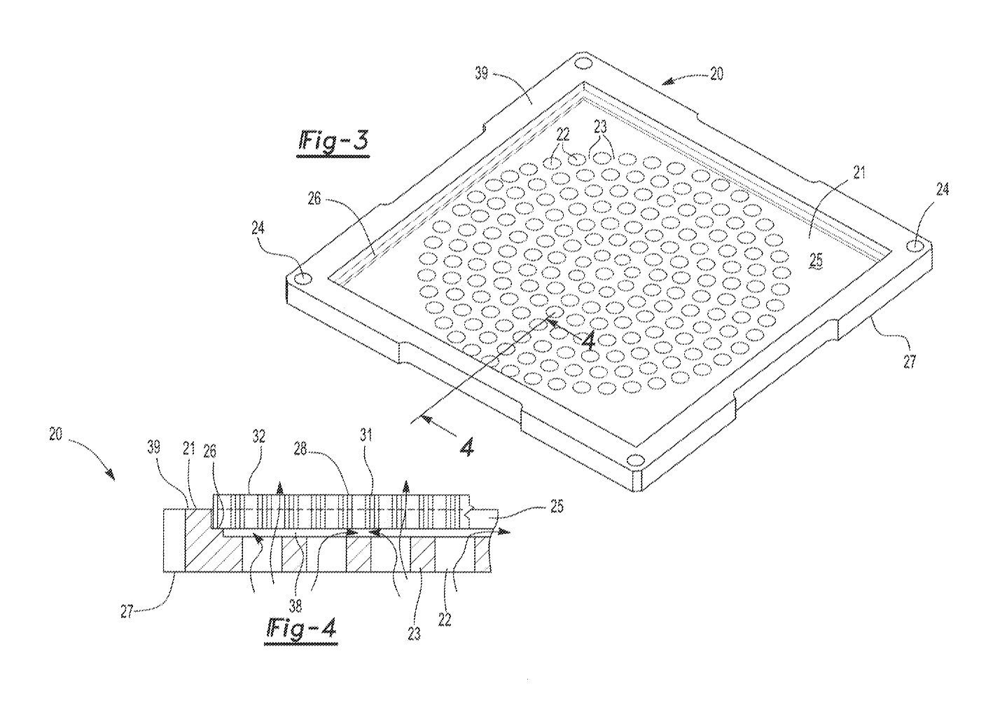

FIG. 3 shows a carrying structure comprising one embodiment of a support sheet 20. FIG. 4 shows a cut away view of the support sheet along line 4-4 which is perpendicular faces 21 and 27. The support structure has two faces, a top face 21 and a bottom face 27. Located in the center portion of the support structure 20 is a plurality of holes 22 having material located about the holes 23. The support structure has a recess 25 located in the top face 21 of the support structure 20. The recess 25 is defined by a raised section 29 disposed about the periphery of the top face 21 of the support sheet. About the periphery of the recess is a ledge 26. The ledge 26 functions to hold a carrying sheet 28 above the portion of the recess 25 in which the holes 22 are located so as to form an air gap 38 such that a fluid, for example air, can flow along face 21 inside of ledge 26 and through all of the carrying sheet 28 not resting on ledge 26. Also shown seated on the support structure 20 is a carrying sheet 28. In particular the carrying sheet 28 rests on the ledge 26 such that there is an air gap 38 between the carrying sheet 28 and the top face 21 of the support structure 20 which is surrounded by the ledge 26. The air gap 38 is sufficient to allow a fluid to flow along the central portion of the support structure 20 and through the portion of the carrying sheet 28 not resting on the ledge 26. The support structure 20 also has located at each corner of the structure indexing holes 24 adapted for matching with posts on a conveyor belt to hold the structure in place on a conveyor belt while the structure is passed through an oven as described herein. The carrying sheet 28 has a honeycomb structure with two faces 30, a plurality of walls 31 and holes 32 which define a hexagonal pattern of a honeycomb structure. The walls 31 and holes 32 of the carrying sheet are perpendicular to the face 30 of the carrying sheet 28 and adapted to set perpendicular to the face 21 of the support structure 20.

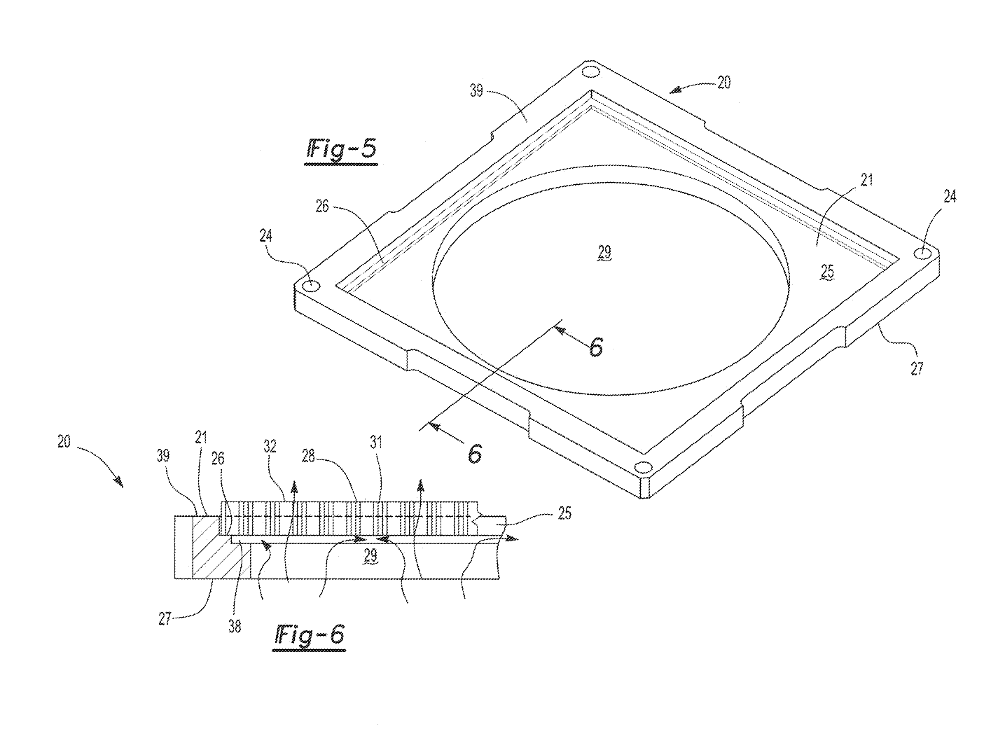

FIG. 5 shows a second embodiment of a support structure 20 with a carrying sheet 28 shown above the support sheet 20 and arrows showing where the carrying sheet 28 rests on the support sheet 20. The significant difference from FIGS. 3 and 4 is that the center of the support sheet is removed and the ledge 26 is circular in shape forming a circular opening 29 in the support sheet 20. FIG. 6 shows a cut away along line 6-6 which is perpendicular to faces 21 and 27. FIG. 6 also shows a carrying sheet 28 above the support sheet 20 and where the carrying sheet 28 rests on the support sheet 20. The carrying sheet 28 rests on the ledge 26 in the recess 25. The carrying sheet 28 and the lop face 21 of the support sheet 20 form an air gap 38. Arrows are included which show the flow of a drying fluid from below the support sheet, to the passages in the carrier sheet 32.

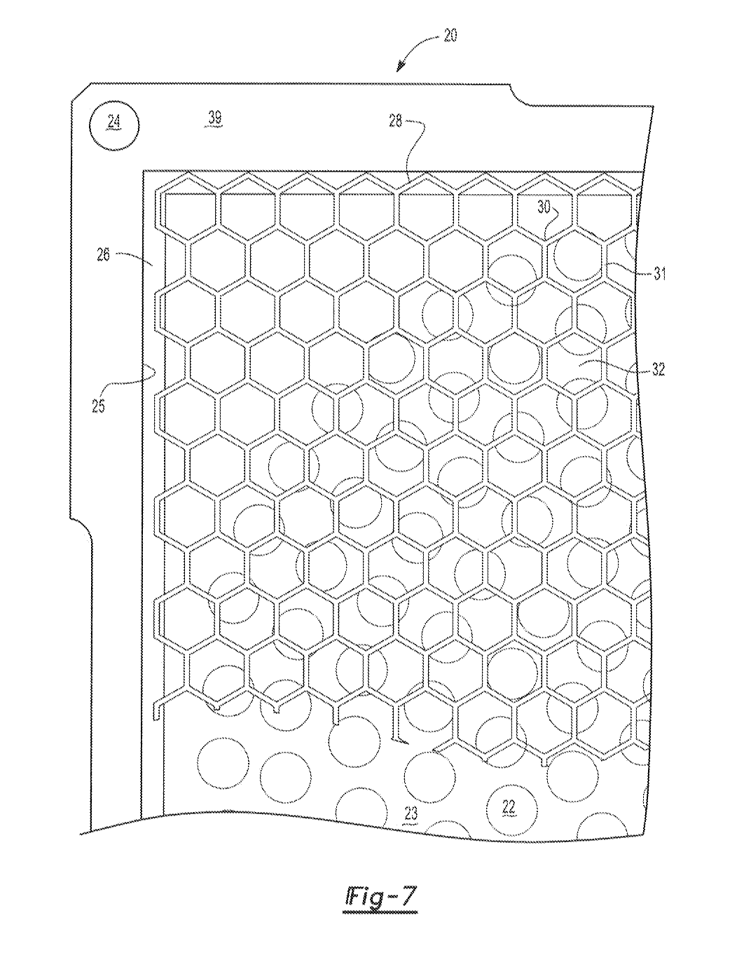

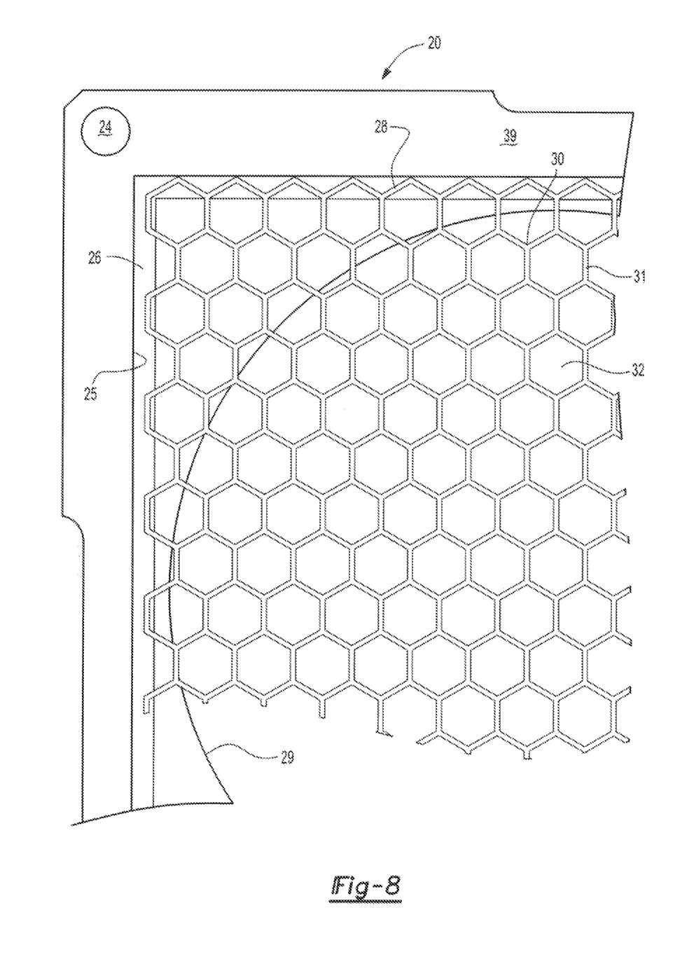

FIG. 7 shows a view of a carrying sheet 28 disposed on a support structure 20 of the first embodiment from above the carrying sheet looking down through the carrying sheet to the support structure. Shown is the ledge 26 on which the carrying sheet 28 rests. Also shown is the face of the carrying sheet 28 with the walls 31 and holes 32 forming a honeycomb structure. Also visible below the carrying sheet 28 are the plurality of holes 22 and material 23 between the plurality of holes 22. The raised portion 39 of the face 21 of the support sheet is also shown. FIG. 8 is a similar view of a carrying sheet 28 above a support sheet 20 of the second embodiment. The carrying sheet 28 is supported on ledge 26 which is circular which forms an open area 29 in the center of the support sheet 20.

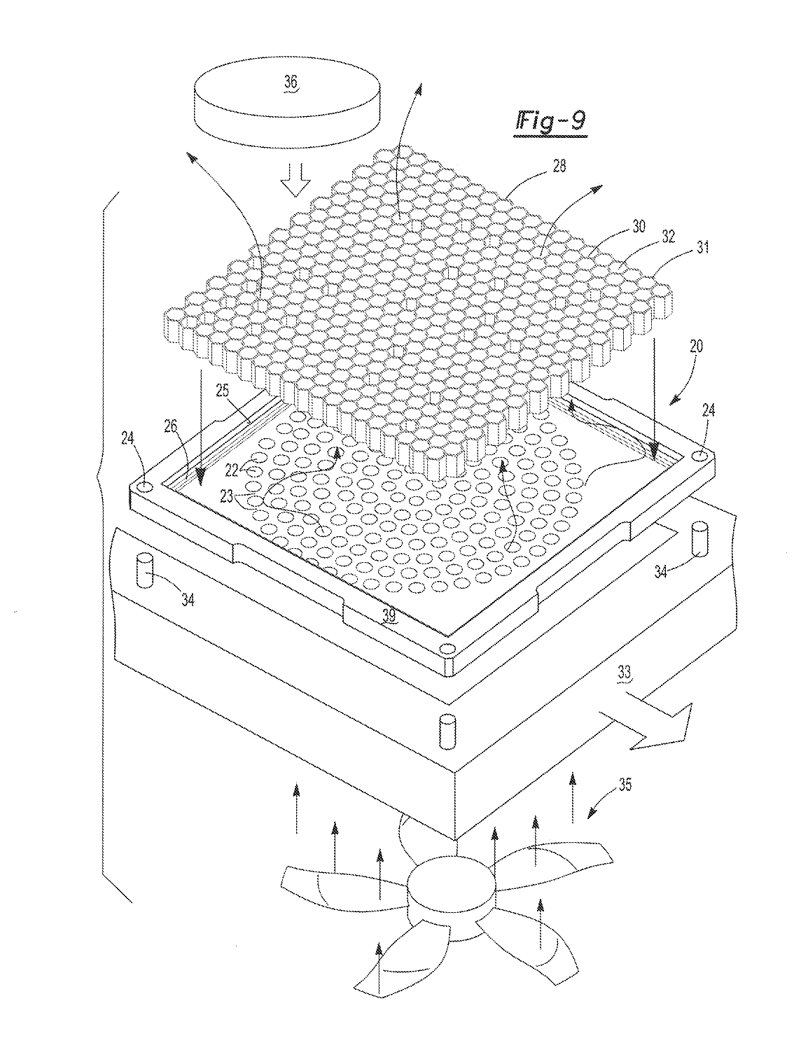

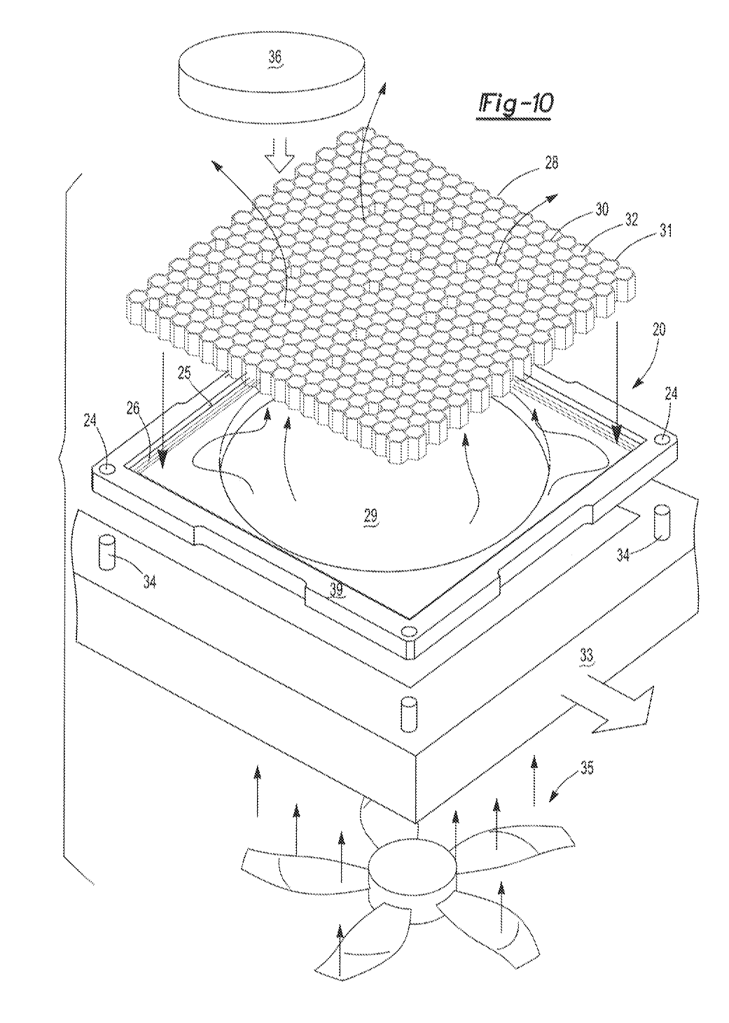

FIG. 9 shows a support sheet 20 of the first embodiment in relation to a conveyor belt 33 having posts 34 adapted for the indexing holes 24 of the support sheet to set upon. The posts 34 hold the support sheet 20 in place on the conveyor belt 33 while the support sheet and carrying sheet with a wet ceramic greenware body 36 place on the carrying sheet is passed through processing steps, such as through a drying oven. FIG. 9 shows a carrying sheet 28 above the support sheet 20 with arrows showing where it would rest on the support sheet 20. Also shown is a wet ceramic greenware body 36 and where the body 36 is to rest while being passed through an oven. FIG. 9 also shows a fan 35 adapted for passing air to and through the support sheet 20, the carrying sheet 28 and the wet ceramic greenware body 36. FIG. 10 is similar to FIG. 9 except the carrying sheet 28 of the second embodiment is used. In both embodiments 1 and 2 the carrying sheet 28 is self supporting and the support sheet primarily functions to facilitate movement of the wet ceramic body on a convenyor belt through processing.

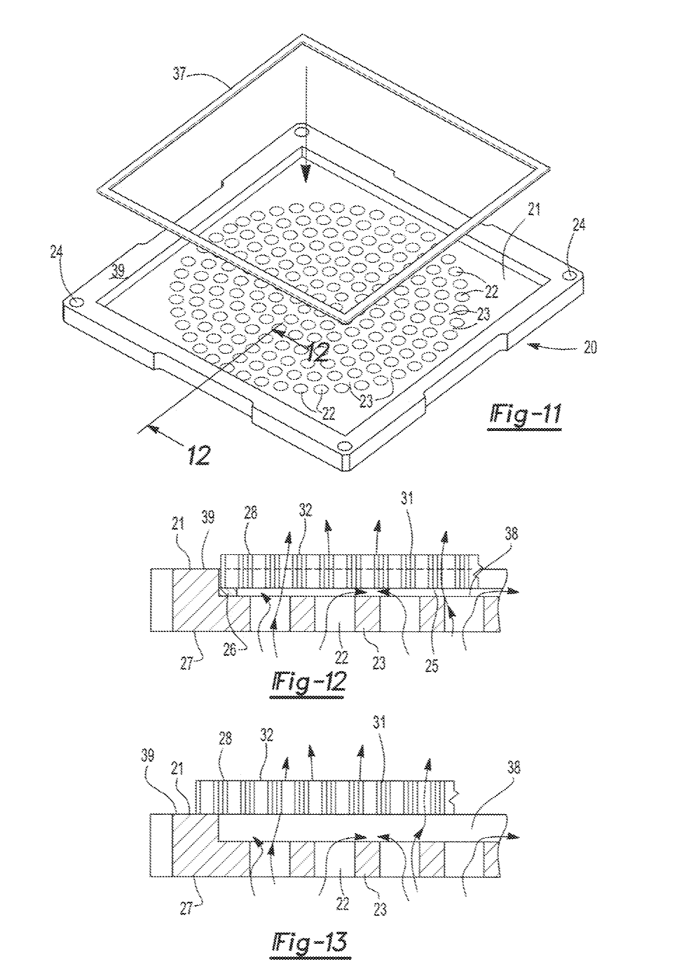

FIG. 11 shows the first embodiment of a support sheet having a ledge in the form of an insert 37. The arrow shows where the insert 37 sets into the carrying sheet 20 on its top face 21. FIG. 11 shows the insert 37 is set inside the raised portion 39 of the face 21 of the support sheet. FIG. 12 is a cutaway of FIG. 11 along lines 12-12 wherein the cut shown is perpendicular to face 21. Also shown is a carrying sheet 28 set in the recess 25 on ledge 25 to form an air gap 38. An arrow shows the flow of fluid through holes 22 into and through the air gap 38 and to and through the passages 32 in the carrying sheet 28. The insert 37 can be used with a support sheet wherein the center of the sheet is open as shown in embodiment 2, see element 29, FIGS. 5 and 6. The insert can be of any shape that raises the carrying sheet and which allows fluid flow to the wet ceramic greenware body

FIG. 13 shows another embodiment wherein the carrying sheet 28 is placed on the raised portion 39 about the periphery of the face 21 of the support sheet 20 such that the recess 25 forms the air gap 38 that allows a drying fluid to flow therethrough and to the passages 32 in the ceramic sheet 28.

### Specific Embodiments of Invention

The following examples are included for illustrative purposes only and are not intended to limit the scope of the invention. Unless otherwise stated, all parts and percentages are by weight.

### Examples

A number of wet ceramic (mullite precursor) greenware bodies are prepared as described in U.S. Pat. No. 6,963,554 (incorporated herein by reference). The wet ceramic bodies are either placed on a conventional carrier plate, as shown in FIGS. 1 and 2, or a carrier structure of the invention, as shown in FIGS. 5 and 6, and passed through an oven as described herein after. The conventional carrier plate has a dimension from the perspective of the opposing faces, 24.76 cm×24.76 cm, with a thickness of 1 cm, machined from a polysulphone plate with 195 holes of 1 cm diameter and spaced by 0.5 and 1.0 cm of walls of solid polysulphone. Together the two plates of the support plate and the carrier plate (sheet) comprise the carrier structure. The support plate is additionally characterized by having two different level recesses machined into the plate (shallow and deep): the shallow recess is intended to hold the carrier plate of the invention, whereas the deep recess serves the function of delivering drying fluid and acts like a plenum for delivery sideways and upwards to the ceramic ware. The deep recess is machined with large diameter holes (2 cm in diameter) with 1 cm solid bridging material (walls) between holes which afford rigidity to the entire assembly. A carrying plate of the invention has a dimension from the perspective of the opposing faces, 24.76 cm×24.76 cm, with a thickness of 2 cm, and comprises a thermoplastic-honeycomb sheet of a polyetherimide honeycomb of 0.35 cm cell diameter with wall thickness of 0.02 cm. The polyether imide honeycomb structure is available from Tubus Bauer, under the trademark Ultem™.

Wet greenware ceramic honeycomb filters are placed alternatively on top of conventional plates and carrying structures of the invention on a dryer conveying belt. Wet extruded honeycomb ceramic greenware parts for the tests are nominally 2,500 grams in weight, 20.32 cm in diameter, and 15.4 cm high. Cell density is nominally 200 CPSI (cells per square inch). Starting moisture content is nominally between 27 and 31 percent. The wet extruded honeycomb ceramic greenware parts are placed on the carrier plates with one face having the end of each flow channel placed on the carrier plates. The carrier structures are placed on a conveyor and passed through an oven and exposed to temperatures of about 65 to about 100° C. with air blown from below the conveyor into and through the flow passages in the wet extruded honeycomb ceramic greenware parts. The residence time in the oven is about 45 minutes. Over a period of 4 months approximately 500 parts are dried using carrier structures of the invention and only 2 percent of such parts show cracks or defects on the surface; and approximately 500 parts are dried using the conventional carrier structures and 90 percent of such parts show cracks or defects on the surface.

The preferred embodiment of the present invention has been disclosed. A person of ordinary skill in the art would realize however, that certain modifications would come within the teachings of this invention. Therefore, the following claims should be studied to determine the true scope and content of the invention. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Parts by weight as used herein refers to compositions containing 100 parts by weight. The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

What is claimed is:

1: A method comprising
a) placing wet ceramic greenware body on a carrying structure, and
b) exposing the wet ceramic greenware body to conditions such that a carrier fluid in the ceramic greenware body is substantially removed;
wherein the carrying structure contains a carrying sheet comprising a material which retains its shape under drying conditions, the sheet having two flat parallel faces and a plurality of walls perpendicular to the flat parallel faces wherein the walls form a plurality of flow passages communicating between the two faces, the largest distance between any two walls in the carrying sheet is 6 mm or less and the walls have a sufficient thickness to support the wet ceramic greenware body under drying conditions without deforming and the area of the flow passages measured parallel to the two faces is from about 60 to about 99 percent.

2: The method according to claim 1 wherein the carrying structure comprises one or more polymeric materials, glass, ceramic materials, composites, blends, alloys or mixtures thereof.

3: The method according claim 2 wherein the carrying structure comprises a polymeric material which exhibits a heat deflection temperature and a modulus such that the carrying sheet does not deform under drying conditions.

4: The method according to claim 3 wherein the polymeric material comprises polyether imide, polysulfone, fiber reinforced nylon, polyether sulfone, polycarbonate, polyphenylene ether, blends or alloys thereof.

5: The method according to claim 1 wherein the carrying structure comprises a carrying sheet of sufficient thickness to prevent the carrying sheet from deforming under drying conditions.

6: The method according to claim 1 wherein the carrying structure comprises a carrying sheet on a support plate wherein the support plate has sufficient stiffness under drying conditions to prevent the carrying sheet from deforming under drying conditions.

7: The method according to claim 1 wherein the wet ceramic greenware body on the carrying structure is placed on a conveying means and passed through an oven and exposed to elevated temperatures sufficient to dry the ceramic greenware part.

8: The method according to claim 1 wherein a drying fluid is passed over, around and/or through the wet ceramic greenware body during drying.

9: The method according to claim 3 wherein the polymeric material of the carrying sheet is transparent to microwaves.

10: The method according to claim 3 wherein the polymeric material of the carrying sheet exhibits a heat deflection temperature and a modulus such that the carrying sheet does not deform under drying conditions.

11: The method according to claim 1 wherein the wet ceramic greenware body is a flow throw filter having two opposing parallel faces and a plurality of channels communicating between the two faces.

12: The method according to claim 11 wherein the drying fluid flows in the same direction as the channels in wet ceramic greenware body and flows through the channels.

13: The method according to claim 1 wherein the cross sectional shape of the wet ceramic greenware body is round, oval or irregular and one face of the wet ceramic greenware body is placed on the carrying sheet and the drying fluid is passed through the carrying sheet and the wet ceramic greenware body.

14: The method according to claim 11 wherein the wet ceramic greenware body has one or more planar exterior surface perpendicular to the direction of the flow passages and one or more of the planar exterior surfaces of the wet ceramic greenware body is placed on the carrying sheet and the drying fluid is passed through the flow passages of the wet ceramic greenware body.

15: The method according to claim 6 wherein the support structure is fabricated from the same polymeric material as the carrying sheet.

16: The method according to claim 6 wherein the polymeric material of the carrying sheet and optionally the support structure exhibits a heat deflection temperature of from about 163 C.° to about 232 C.° and a modulus of about 2.5 to about 3.5 GPa.

17: The method according to claim 3 wherein the carrying structure consists of a carrying sheet having a thickness of about 1.0 cm to about 4.0 cm.

18: The method according to claim 6 wherein the carrying structure consists of a carrying sheet having a thickness of about 0.5 cm to about 3.0 cm and a support structure having a thickness of about 0.5 cm to about 2.0 cm.

19: The method according to claim 6 wherein support plate has an open volume in the plane parallel to the face of the carrying sheet of about 60 to about 90 percent such that a drying fluid can pass through the support plate to the carrying sheet and the wet ceramic structure.

20: The method according to claim 6 wherein the distance between the walls of the carrying sheet is between about 2.5 and about 3.5 mm.
